(19) United States
(12) Patent Application Publication
(10) Pub. No.: US 2014/0357216 A1
(43) Pub. Date: Dec. 4, 2014

(54) REMOTE HATCH POSITION AND CONFIRMATION

(71) Applicant: Cartasite, Inc., Denver, CO (US)

(72) Inventor: David L. Armitage, Golden, CO (US)

(73) Assignee: Cartasite, Inc., Denver, CO (US)

(21) Appl. No.: 14/295,487

(22) Filed: Jun. 4, 2014

Related U.S. Application Data
(60) Provisional application No. 61/830,688, filed on Jun. 4, 2013.

(51) Int. Cl. H04W 4/22; H04W 4/02

(52) U.S. Cl. CPC H04W 4/22; H04W 4/02
USPC 455/404.2

(57) ABSTRACT

Systems, methods, and software are provided herein for safety device status and confirmation. In at least one example a safety device maybe positioned on or near safety or other hatches of a well site to indicate the position. A status alert may be sent to a remote station via a satellite or other network. The remote station may then communicate with a nearby worker via a communication device, such as a smart cellular telephone indicating the location and/or position of the hatch.

### CROSS REFERENCE TO RELATED APPLICATIONS

This application claims priority to, and benefit from, provisional patent application Ser. No. 61/830,688, entitled “SYSTEMS AND METHODS FOR WORKER LOCATION AND SAFETY CONFIRMATION”, filed Jun. 4, 2013, which is incorporated by reference for all purposes.

### TECHNICAL BACKGROUND

Global communication safety systems are designed to keep users connected and safe from anywhere on the planet. Many workers work alone, and may work in hazardous or non-hazardous locations and situations. Workers should also be in a work area during work hours.

Furthermore, safety hatches, safety devices, and other equipment must be closed or otherwise put in a safety mode or position.

### OVERVIEW

A method and system for safety confirmation is disclosed. A safety device may provide an indication to a communication device. The communication device may determine a location of the safety device, and create an alert based at least in part on the safety indication and the location.

The method and system may include monitoring a user device for a concerning event, notifying the user of the concerning event, receiving a recognition from the user, and if the alert is not recognized, sending an alert to a remote station.

### BRIEF DESCRIPTION OF THE DRAWINGS

FIG. 1 illustrates a system for worker location and/or safety confirmation according to an example.

FIG. 2 illustrates a system for worker location and/or safety confirmation according to an example.

FIG. 3 illustrates a flowchart for operating a user device for worker location and/or safety confirmation according to an example.

FIG. 4 illustrates a system for worker location and/or safety confirmation according to an example.

FIG. 5 illustrates a user interface of a remote or user station according to an example.

### DESCRIPTION

Systems, methods, and software are provided herein for worker location and/or safety confirmation. In at least one example, a user will carry a user or communication device which include the functionality to monitor for safety device indications. The user device may also be capable of determining location information for the user and/or safety device. The user device may create an alert based on the location or safety information. If the user does not recognize the alert, a notification may be sent to a remote location. If the user recognizes the alert, the user may then go to the safety device to clear the indication.

Workers at a well site may have hatches and other doors and locations used for entering various areas. These doors and hatches need to be closed when the worker leaves.

One particular hatch is called a thief hatch. If this hatch is left open, the site may release hydrocarbons, and/or other gasses and material that are harmful. Furthermore, the service company may be fined for leaving these hatches open.

A monitoring or safety device maybe positioned on or near the hatches to indicate the position. An alert may be sent to a remote station via a satellite or other network. The remote station may then communicate with a nearby worker via a communication device, such as a cellular telephone indicating the location and/or position of the hatch.

The communication device can determine position of the communication device to indicate if the worker in still in the site or is leaving the area. The communication device may then create, communicate, or send a notification to the user regarding the hatch. If the user does not acknowledge the alert, or fix the problem, an alert may be sent to a remote location or other device.

This may reduce the likelihood of excess emission form a site, as well as reduce fines levied to a company. Furthermore, it can promote worker safety and thoroughness.

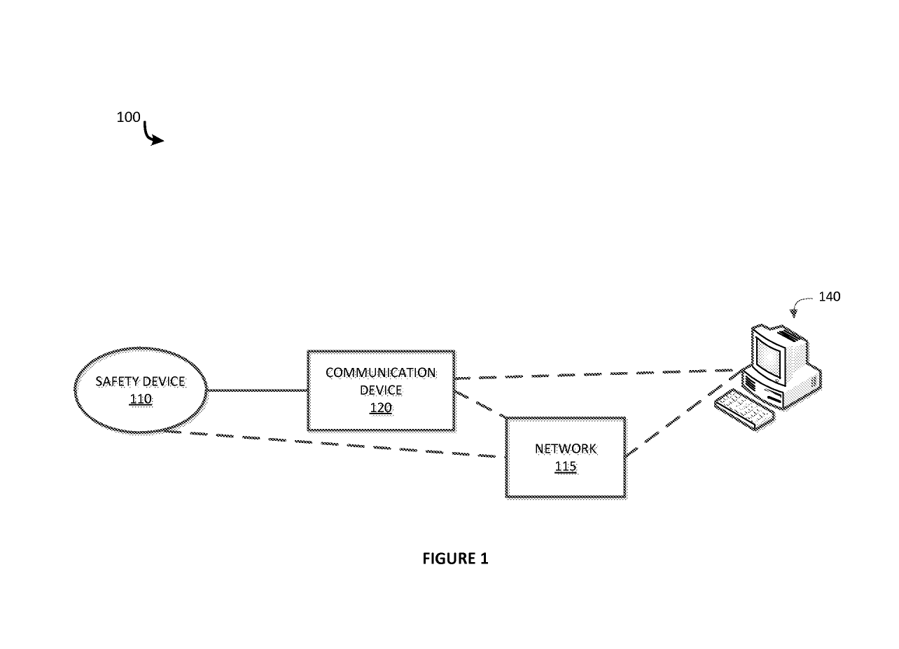

FIG. 1 illustrates a worker location and/or safety confirmation system 100 according to one example. System 100 includes safety device 110, network 115, communication device 120, and remote station 140.

Safety device 110 is connected to communication device 120 via a Bluetooth, Wi-Fi, or other form of wireless communication. In turn, communication device 120 is connected to remote station 140 via network 115. Communication device 120 may be connected to network 115 via cellular communication, Bluetooth, Wi-Fi, satellite, or other form of wireless communication. Network 115 may include a cellular, satellite, and/or the Internet or any other type of network or communication system.

Safety device 110 can be any device capable of monitoring for safety information. Safety device 110 can be configured to monitor for concerning events such as location, a lack of movement, hatch open, over time, or time out condition, or any other indication of a concerning event, or any other form of concerning event including combinations thereof. Further, safety device 110 can be configured to transmit an alert via network 115 and/or communication device 120 upon indication of a concerning event and can be configured to receive information from user station 120 and/or remote station 140.

Communication device 120 can be any device capable of receiving communication from safety device 110, and capable of communication with remote station 140. In one example, safety device 120 can also be configured to receive information from remote station 140, and send alerts to communication device 110 and remote station 140.

Similarly, network 115 can include any device and/or system capable of receiving alerts and/or communications from safety device 110, and capable of sending alerts to remote station 140. Furthermore, network 115 can also be configured to receive alerts from remote station 140, and send alerts to safety device 110.

Remote station 140 can be any device capable of receiving alerts from communication device 120 and safety device 110. Remote station 140 may include a server computer, desktop computer, a tablet computer, a smart phone, telephone, or any other device capable of receiving alerts and/or communications from communication device 120 and/or network 115.

In an example, remote station 140 can transmit the alert to communication device 120, which can transmit information to other devices such as other server computers, desktop computers, tablet computers, telephones, or the like. In one example, remote station 140 can be configured to transmit an alert to communication device 120, which may be forwarded to other devices in the area, remote station, or other devices.

If a concerning event occurred, communication device 120 may produce, create, receive, or otherwise indicate to a user that the event has occurred. If the user does not acknowledge the alert, communication device 120 may try to communicate an alert via a cellular call or alert via network 115. If unable to communication via a cellular call or alert, device may try to communicate via a short message service (SMS) or other message service via network 115. Device may also try to communicate via any other method using network 115.

If device 110 or 120 is unable to communicate via network 115, device may try to communicate via Bluetooth or other method or protocol. Communication device 120 may try to use a satellite network to communicate with remote station 140 or other communication device is area.

In an example, safety device 110 may indicate a hatch is open. Safety device 110 may communicate via a satellite network 115 to remote station 140. Remote station 140 may provide an alert that the hatch is open. Remote station 140 may also be capable of indicating other employees in the area.

The user or remote station 140 may then contact a user in the area with a message that the hatch is open, and maybe a message to go close it. An employee in the area may have a communication device 120 to receive the communication about the location and position of the hatch. Communication device 120 may also receive the message to close the hatch.

In another example, device 120 may be a smart phone with an application capable of operating as described herein. Device 120 may try to communication via cellular, bluetooth, messaging, Internet, wi-fi, satellite, or other type of communication directly or via network 115 to remote station 140, and/or safety device 110.

Safety device 110 may try to communicate with communication device 120 via Bluetooth or other type of communication. Communication device 120 may then communicate via a satellite, cellular or other network to remote station 140.

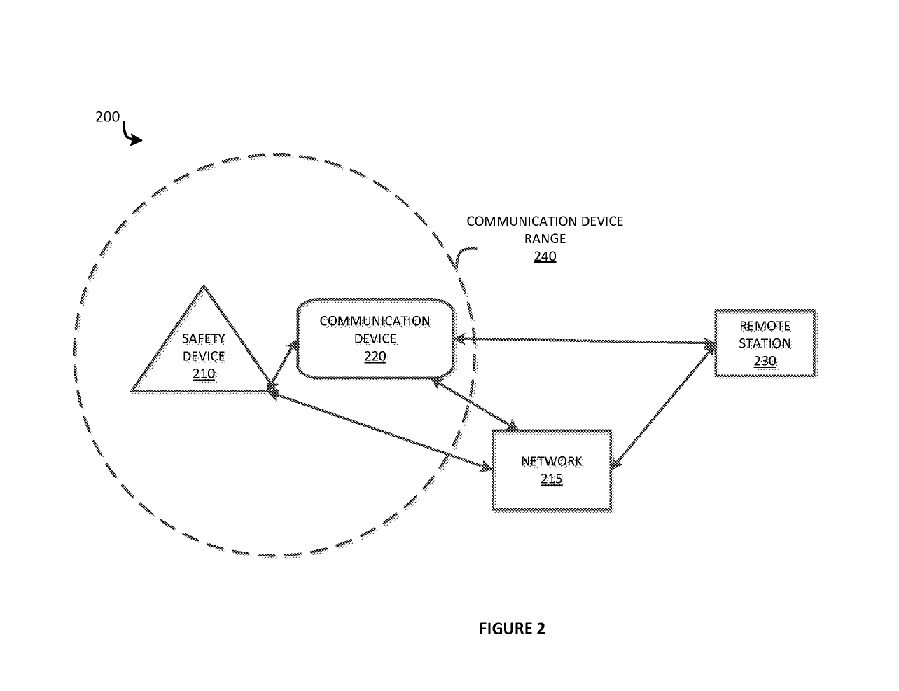

FIG. 2 illustrates a system 200 capable of worker location and/or safety confirmation according to one example. System 200 includes safety device 210, network 215, communication device 220, and remote station 230.

Safety device 210 is connected to communication device 220 via a Bluetooth, Wi-Fi, or other form of wired or wireless communication. In turn, communication device 220 is connected to remote station 230 via satellite communication network, Internet network, cellular, wi-fi, the Internet, or any other communication network including combinations thereof.

Similarly, safety device 210 may be connected to network 215 via cellular, Bluetooth, Wi-Fi, or other form of wireless communication. In turn, network 115 is connected to remote station 230 via communication network 215. Network 215 may include, satellite communication network, cellular, Wi-Fi, the Internet, or any other communication network including combinations thereof.

Safety device 210 can be configured to monitor for concerning events such as lack of movement from the user, position of various items, location, a user triggering a button or a switch, or any other form of concerning event including combinations thereof. Further, safety device 210 can be configured to transmit an alert communication device 220 or network 215 upon detection of a concerning event and also, in at least one example, can be configured to receive information from user station 220 via user station 220 and/or network 215.

Communication device 220 can be any device capable of receiving an alert from safety device 210 from within the communication device range 240, and capable of transmitting a second alert to remote station 230 upon receipt of an alert from safety device 210. Communication device 220 may further be configured to receive alerts from remote station 230 and transmit alerts to safety device 210.

Network 215 may include a cellular network and can include any devices or systems capable of receiving an alert from safety device 210 from within the range of network 215, and capable of transmitting a second alert to remote station 230 upon receipt of an alert from safety device 210. Communication device 220 may further be configured to receive alerts from remote station 230 and transmit alerts to safety device 210 via network 215.

Remote station 230 can be any device capable of receiving alerts from communication device 220. These alerts may include the type of concerning event that occurred, the location of the alert, as well as any other information about the status of safety device 210 including combinations thereof. Remote station 230 may also be configured to transmit alerts to communication device 220 and network 215, which may be forwarded to other user devices in or generally near the area.

Safety device 210 can monitor a device or item and provide an indication of a concerning event, such as a hatch being left open. The indication may be received by communication device 220 by bluetooth-type communication is communication device 220 is within range 240.

If communication device is not near safety device 210, it may mean the user is leaving the area. Communication device 220 may then provide an alert to the user that the hatch has been left open. The user may acknowledge the alert and go back and close the hatch, thereby eliminating the indication.

If the user does not acknowledge or clear the alert, the safety device 210 and/or the communication device 220 may then communicate the alert via network 215 to other users including remote station 230. In an example, user station may include the supervisor's computer and the supervisor may alert the user or other users in the area of the safety condition. This may insure the indication is cleared before the user travels a relatively great distance away.

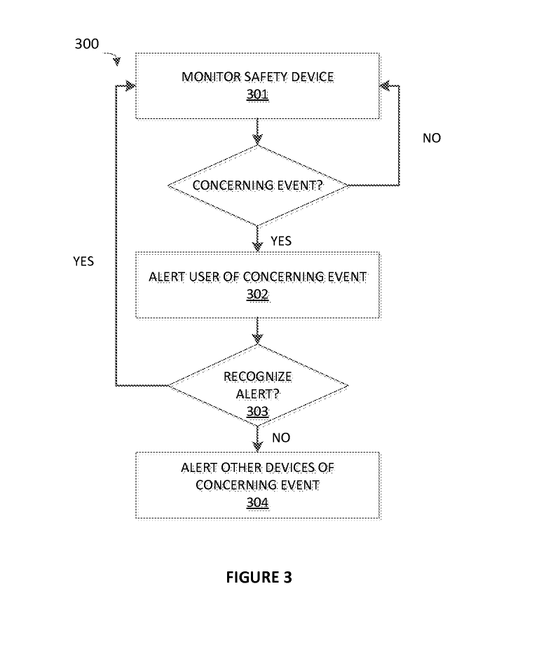

FIG. 3 illustrates a flowchart 300 for operating a system according to one example. The method begins at step 301 by monitoring safety device 110 210 for information. This monitoring could be done using switches, or user inputs or indications, or any other method of monitoring a device for a concerning event. If no concerning event has occurred, the system will return to monitoring for a concerning event. However, a concerning event has occurred the system will progress to step 302.

At step 302, safety device 110 210 will alert the user of a concerning event. The alert may go to a remote station and/or a communication device. This first alert may be visual, audible in the form of a speaker on the device, a vibration, or any other method of notifying the user of a concerning event. A concerning event may be based at least in part on information from safety device 110 and/or location information from safety device 110, and/or communication device 120. It will be appreciated that many other concerning events may be based on other information, including information from safety device 210 only.

The remote station 140 may then send an indication to a communication device with information about the concerning event, such as a hatch being open and the location of the hatch. Thereafter, at step 303, the system will determine if a user responded to the alert. The response could include shaking the device to activate the accelerometer, pressing a button, flipping a switch, or any other form of user interface to recognize the alert. If the user recognizes the alert, the system will return to step 301 and monitor for a concerning event. However, if the user does not recognize the alert, remote station can transmit a second alert to other devices and/or users (step 304).

Alerting other devices (304) may include using network 115, 215 to communicate with communications device(s) 120 220. The communication may include a cellular communication, satellite, Internet, wi-fi, SMS or other messaging communication, or any other type of communication the devices are capable of.

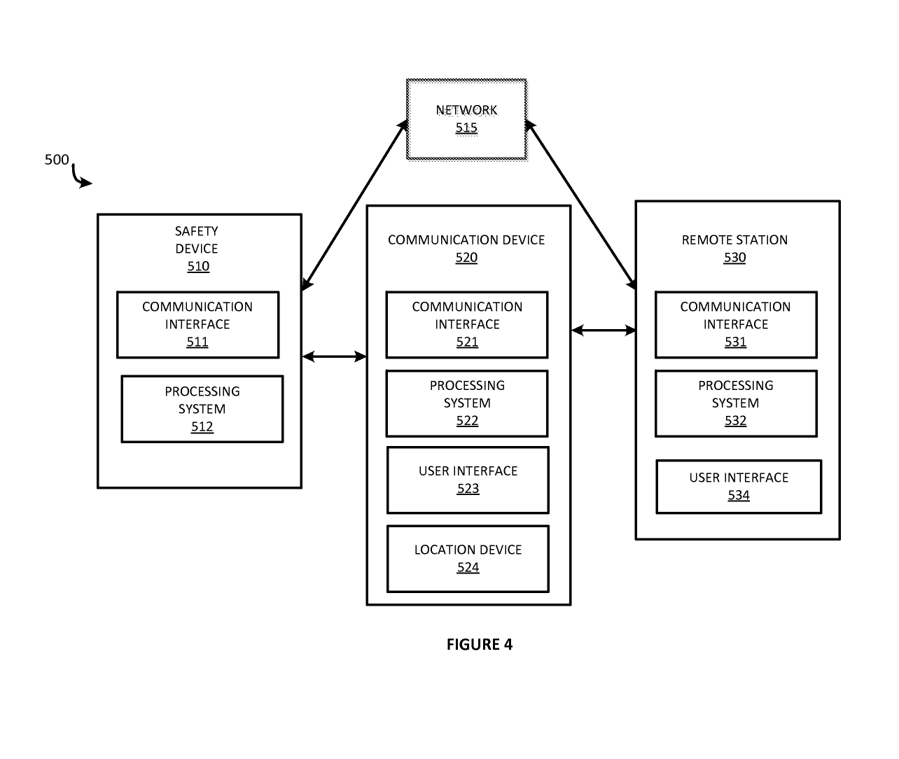

FIG. 4 illustrates a system 500 according to one example. System 500 comprises safety device 510, communication device 520, network 515, and remote station 530.

Safety device 510 can be connected to communication device 520 via a Bluetooth, Wi-Fi, or other form of wireless connection. Communication device 520 can be connected to remote station 530 via network 515, which may include satellite communication network, Internet network, cellular, wi-fi, the Internet, or any other communication network or system including combinations thereof. Safety device 510 can also be connected to remote station 530 at least in part via network 515.

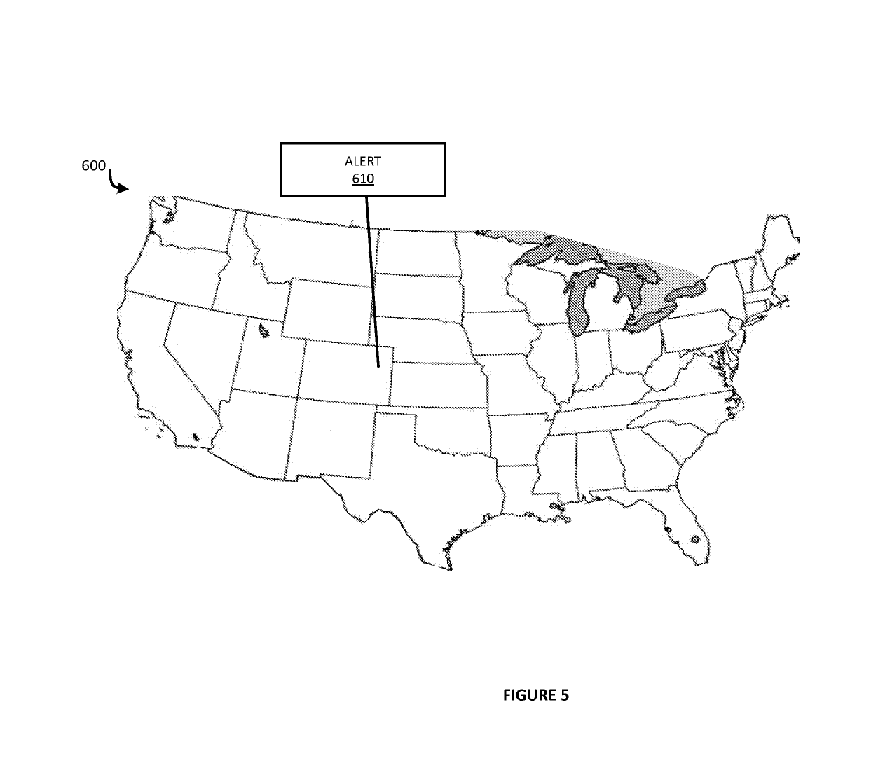

In FIG. 5, safety device 510 comprises communication interface 511, and processing system 512. Processing system 512 is configured to monitor data from safety device 510 for information. This information could include location of an item or device, a lack of movement, hatch open, a press of an emergency button, over time, or time out condition, or any other indication of information. When device 510 determines an event has occurred, system 512 directs communication interface 511 to transmit an alert to communication device 520 and/or network 515.

Safety device 510 may include a switch connected to a satellite communication module. The switch may determine when a hatch is open and use the communication interface 511 (satellite communication) to communicate the information to remote station 530 and/or another device or location.

After the transmission of information from safety device 510, the information is received at communication device 520 and/or remote station 530. Communication device 520 and/or remote station 530 are configured to monitor for information from safety device 510 as further described by operation 300.

Communication device 520 includes communication interface 521, processing system 522, user interface 523, and location device 524. Communication interface 521 is capable of sending and receiving information. User interface is capable of displaying or informing user of alerts. Location device 524 may be capable of providing location information of communication device 520 and/or safety device 510.

Device 520 is also a representation of other devices capable of receiving communications from remote station and other devices.

If a first alert is sent to remote station 530 via network 515, the first alert may be transmitted to remote station 530. This first alert may include the location of the device, the concerning events that occurred (position, location, lack of movement, button press, etc.), or any other information regarding the status of safety device 510.

If the alert is sent to remote station 530 via communication device 520, upon the receipt of the alert at communication interface 521, communication device 520 prepares to send a second alert using communication interface 521 to remote station 530. This alert is sent if the user does not acknowledge the alert at communication device 520.

This second alert may include the location of the device, the concerning events that occurred (position, location, lack of movement, button press, etc.), or any other information regarding the status of safety device 510. The alert may be the same or different than the first alert from safety device 510 to user station 520.

After the alert transmission from communication device 520 or via network 515, the alert is received at remote station 530. Remote station 530 can be configured with communication interface 531 and processing system 532. Upon receipt of the alert, processing system 532 can be configured to display the alert, can be configured to transfer the alert to another device such as another server computer, desktop computer, tablet computer, or telephone, can be configured to store the alert, or any other possible action with the alert.

Examples of remote station 530 include server computers, desktop computers, tablet computers, and telephones. In one example, remote station 530 can create an alert that is transferred to communication device 520, and/or to other user devices. The alert could include the location, position information, and other information about the safety device.

The location information may be received from another source, such as a database. The location information may have been inputted or predetermined when the safety device was installed.

FIG. 5 may illustrate a remote station 140, 230, 540, or communication device 120, 220 520 user interface 600. User interface 600 may include a map or other indication. User interface 600 may also include alerts 610 from safety device(s) 110, 210, 510, or communication device(s) 110, 120, 520. The alert may include the location of the device, the concerning events that occurred, mode the device is in, type of environment the device is in, or any other information regarding the status of safety device 110, 210, 510. This may aid the monitor of remote device with information for getting help to the user. This may provide a higher degree of safety than without this functionality.

Although one alert is shown, many alerts may be shown on the user interface 600. User interface 600 may also show location of other assets, including other users, devices, and/or communication devices associated with the system.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for safety device confirmation, comprising:
receiving an indication from a safety device at a remote station;
receiving location information about the safety device;
determining if a concerning event exists based at least in part on the indication information and the location information, and
providing a notification of the concerning event to a communication device or the remote station, if it is determined a concerning event has occurred.

2. The method of claim 1, further comprising receiving an acknowledgement of the notification from the communication device or the remote station.

3. The method of claim 2, further comprising transmitting an alert to other devices, if the acknowledgement is not received.

4. The method of claim 3, wherein the remote station comprises a remote computer and the communication device and the other devices comprise a smart cellular telephone.

5. The method of claim 3, wherein the transmitting an alert to other devices comprises transmitting an alert at least in part via a cellular communication network.

6. The method of claim 1, wherein the safety device comprises a hatch position indicator switch.

7. The method of claim 1, wherein the safety device comprises a satellite communication module.

8. A system for hatch position indication, comprising:
a remote station configured to receive hatch position information from a safety device, the remote station further configured to provide a notification comprising the hatch location and position to a user interface and to a communication device, the remote station further configured to receive an acknowledgement of the alert from the communication device or the remote station, and if no acknowledgement is received, transmit the notification to other devices.

9. The system of claim 8, wherein the remote station comprises a remote computer and the communication device and the other devices comprise a smart cellular telephone.

10. The system of claim 9, wherein the transmitting the notification to other devices comprises transmitting the notification at least in part via a cellular communication network.

11. The system of claim 8, wherein the hatch position information is received at least in part using a network, the network comprising satellite communication capabilities.

12. A method for safety hatch position and confirmation, comprising:
monitoring a safety device for a concerning event by the safety device;
sending information to a remote station at least in part via a network comprising a satellite network, wherein the information comprises information associated with the safety device or the concerning event;
presenting an alert comprising at least a portion of the information via a user interface;
sending at least a portion of the presented information to a communication device;
receiving an acknowledgement from the communication device or the remote station, and
if no acknowledgement is received, transmitting the alert to other devices.

13. The method of claim 12, wherein the remote station comprises a remote computer and the communication device or the other devices comprise a smart cellular telephone.

14. The method of claim 13, wherein the transmitting the alert to other devices comprises transmitting the alert at least in part via a cellular communication network.

15. The method of claim 12, wherein the safety device comprises a hatch position indicator switch.

16. The method of claim 12, wherein the safety device comprises a satellite communication module.
